(19) United States
(12) Patent Application Publication
(10) Pub. No.: US 2018/0199576 A1
(43) Pub. Date: Jul. 19, 2018

(54) AQUEOUS HYPOCHLOROUS ACID SOLUTION

(71) Applicant: FREEKIRA PHARMACEUTICAL INC., Tokyo (JP)

(72) Inventor: Yoshikatsu Ikemoto, Tokyo (JP)

(21) Appl. No.: 15/920,963

(22) Filed: Mar. 14, 2018

Related U.S. Application Data
(63) Continuation of application No. PCT/JP2016/066769, filed on Jun. 6, 2016.

(30) Foreign Application Priority Data
Sep. 16, 2015 (JP) 2015-182718

(51) Int. Cl. A01N 59/00; A23L 3/358

(52) U.S. Cl. CPC A01N 59/00; A23V 2002/00; A23L 3/358

(57) ABSTRACT

Provided is an aqueous hypochlorous acid solution that has an excellent bactericidal effect and high safety. In the aqueous hypochlorous acid solution according to the present invention that has a pH value within the range of 5.5-6.5, starting materials are dissolved exclusively in purified water specified by Japanese Pharmacopeia. The starting materials are sodium hypochlorite for food additives and dilute hydrochloric acid specified by Japanese Pharmacopeia. The pH value of the aqueous hypochlorous acid solution is preferably 6.3.

### TECHNICAL FIELD

The present invention related to hypochlorite solution having excellent bactericidal effects and safety.

### BACKGROUND ART

Conventionally, hypochlorous acid has been utilized for pharmaceuticals, tap water, foods and the like as sodium hypochlorite. Also, hypochlorous acid is commercially available for household products in an aqueous solution form or powder form.

The hypochlorite solution is prepared by mixing sodium hypochlorite (NaClO), dilute hydrochloric acid and water. Both of sodium hypochlorite and tap water are approved substances as food additives, and water is a harmless substance. Therefore, hypochlorite solution is one of highly valued pharmaceutical as the harmless bactericidal agent on a human body.

Recent years, medical devices directly inserted into human body become popular. It is expected that treatment by using such medical devices gives less burden to a patient compared to thoracotomy or laparotomy, and shorter stay in a hospital. On the other hand, inadequate sterilization such medical device increases a risk of infection for the patient. Sometimes, the inadequately sterilized medical devices cause nosocomial infection. In order to avoid such infection, hypochlorite acid solution is used for the sterilization of the medical devices. Since hypochlorite solution is strong alkali higher than pH 12, it remained on the sterilized medical devices may irritate human skin of which pH is in a range between pH 4.5 to 6.0.

In order to weaken such irritation, sodium hypochlorite solution is usually diluted. However, sodium hypochlorite solution causes the problem that it particularly decomposed at pH not higher than 7. Furthermore, under the acidic condition not higher than pH 5, it rapidly generates chlorine gas. Therefore, devices for inhibiting the chlorine gas disclosed in the patent document 1 or 2 are developed.

### PRIOR ART

### Patent Document

Patent document 1: JP patent 4740892
Patent Document 2: JP patent 5307351

However, the hypochlorite solution, which is prepared by using tap water, slightly includes impurities such as metal and the like. Accordingly, it is desired that the hypochlorite solution has extremely high safety and bactericidal effects, and the solution may be approved as pharmaceuticals.

The object of the present invention is to provide the hypochlorite solution having an excellent bactericidal effects and the safety.

### Means for Solving the Problem

The hypochlorite solution of the present invention has the pH range between from 6.0 to 6.5, being prepared by using purified water defined in Japanese Pharmacopoeia.

Raw materials for preparing the hypochlorite solution may be sodium hypochlorite as food additives, and dilute hydrochloride defined in Japanese Pharmacopoeia.

pH of the hypochlorite solution may be 6.0 to 6.5.

pH of the hypochlorite solution may be 6.3.

The hypochlorite solution may contain 150 to 260 ppm of sodium hypochlorite.

The hypochlorite solution may contain 220 ppm of sodium hypochlorite.

### Advantageous Effect of the Invention

According to the hypochlorite solution of the present invention, the hypochlorite solution which is useful for the medical supplies and pharmaceuticals has the excellent microbicidal effect and the safety.

### DESCRIPTION OF THE INVENTION

Hereinbelow, the hypochlorite solution of the first aspect of the present invention is explained.

### (Hypochlorite Solution and Preparation Example Thereof)

Sodium hypochlorite is weighed so as to be the range from 0.018 to 0.026 w/v %, preferably 0.026 w/v %, and mixed with purified water to prepare sodium hypochlorite solution. The sodium hypochlorite solution is prepared so as to have pH 6.0 to 6.5 by using dilute hydrochloric acid (about 9.5 to 10.5 w/v %) and then stirred to mix. The solution may be prepared for containing 150 to 260 ppm of sodium hypochlorite, preferably 220 ppm. For example, the solution may be obtained by using at least 99.9% of purified water and remained less than 0.1% of mixture containing about the same amount of sodium hypochlorite solution with effective chlorine concentration 12% and dilute hydrochloric acid solution with about 10% concentration thereof, when total amount of the solution is 100%.

Note that in the above example for production, the hypochlorite solution is obtained by mixing the raw materials. However, it may be obtained by using an apparatus for producing the hypochlorite solution, which is commercially available. For example, the patent documents 1 and 2 disclose arts related to such apparatuses.

(Component Analysis of the Hypochlorite Solution)

Herein below, the table for the component analysis of the hypochlorite solution is shown.

TABLE 1

| Items to be | | | | | Lot Nos. | | |
|---|---|---|---|---|---|---|---|
| checked | | Specifications | | | 001 | 002 | 003 |
| Properties | | The product is yellow colored liquid | | | OK | OK | OK |
| | | without odor, or with faint chlorine | | | | | |
| | | odor. | | | | | |
| Validation Test | | (1) When 1 mL of sodium hydroxide | | | OK | OK | OK |
| | | (2,500 times diluted), and 0.2 mL of | | | | | |
| | | potassium iodide test solution are added | | | | | |
| | | to 5 mL of the product, the solution | | | | | |
| | | turns yellow. When 0.5 mL of starch | | | | | |
| | | test solution is further added to the | | | | | |
| | | solution, the solution turns deep blue. | | | | | |
| | | (2) When the 0.1 mL of the | | | OK | OK | OK |
| | | permanganate solution (300 times | | | | | |
| | | diluted) is added into 5 mL of the | | | | | |
| | | product and 1 mL of diluted sulfuric | | | | | |
| | | acid (20 times diluted) is added. After | | | | | |
| | | that, when 1 mL of the diluted sulfuric | | | | | |
| | | acid is further added thereto, red-purple | | | | | |
| | | color of the solution is unfaded. | | | | | |
| | | (3) The solution prepared by adding 90 mL | | | OK | OK | OK |
| | | of the product and 10 mL of sodium | | | | | |
| | | hydroxide solution (5 times diluted) has | | | | | |
| | | absorption maximum from the | | | | | |
| | | wavelength between 290 to 294 nm. | | | | | |
| Purity | pH | from 4.5 to 6.5 | No. | 1 | 6.4 | 6.4 | 6.4 |
| Test | | | | 2 | 6.4 | 6.4 | 6.4 |
| | | | | 3 | 6.4 | 6.4 | 6.4 |
| | Total | not more than 0.25% | No. | 1 | 0.03 | 0.03 | 0.03 |
| | Residue | | | | | | |

| | | | | | | |
|---|---|---|---|---|---|---|
| Quantitative | 220 ± 40 ppm | No. | 1 | 256.0 | 259.2 | 251.1 |
| Value | | | 2 | 255.5 | 259.5 | 251.4 |
| | | | 3 | 255.6 | 259.2 | 250.9 |

Also, the purified water used in the present invention has following characteristics:

### (1) Properties

Colorless and odorless

### (2) Purity

Not over than 0.50 mg/L under test for total organic carbon

### (3) Conductivity

When following test is conducted, conductivity at 25° C. is not over than 2.1 μS/cm.

Adequate amount of the purified water is poured into a beaker and then stirred. Temperature of the purified water is adjusted at 25±1° C., and the conductivity pf the water is measured at regular intervals, vigorously stirring the water. The conductivity of the purified water (25° C.) is set the value when change in conductivity/5 minutes becomes not over than 0.1 μS/cm.

(Antimicrobial Test for Gastrointestinal Microbial which Occur Contamination on a Medical Endoscope)
(1) Assay Method
1) Test Microbial

Antimicrobial effect of the hypochlorite solution has been confirmed by using the following test microbial.
Escherichia coli (E. coli)
Salmonella enteritidis (Salmonella)
Candida sp. (Candida)
Pseudomonas aeruginosa (P. aeruginosa)

2) Preparation of Test Samples

In order to prepare the test samples, the hypochlorite solution is diluted so as to be the effective chlorine concentration of at 200, 20, 5, 2, 1, 0.5 ppm. Five mL of the test samples are respectively dispensed into 20 mL size test tubes. Sterilized water without hypochlorite solution is used as a control.

3) Pre-Culture Before the Assay

For both E. coli and Salmonella, these bacteria are cultivated at 35° C. for 20 to 24 hours by standing culture in TSB (Tryptic Soy Broth) to use in the assays. The assay solutions are adjusted by dilution with sterilized deionized water. Bacteria numbers in the solutions are 1.2×10⁶/mL for E. coli, and 1.7×10⁶/mL for Salmonella.

For Candida, they are cultured at 25° C. for 44 to 48 hours in PDA (Potato Dextrose Agar) medium. Cultured bacteria are suspended in the sterilized deionized water to prepare the bacterial solution. The bacteria number is 2.7×10⁶/mL.

For P. aeruginosa, they are cultured by standing culture at 25° C. for 44 to 48 hours in TSB. Culture broth is diluted with the sterilized deionized water to prepare the sample solution. The bacteria number is 2.3×10⁶/mL.

4) Assay Method

In each sample solution with different concentration, 0.2 mL of bacteria solution is inoculated and then mixed. At the time point from the start, 0.5 min., 5 min., and 10 min., 0.2 mL portion is taken out from each sample solution; it is suspended in 1.8 mL of the sterilized deionized water containing 1 mg/mL of sodium thiosulfate. When the solution contains the bacteria, 0.1 mL of the suspension or another sample solution, which is 10-fold diluted solution by using the same sterilized deionized water containing 1 mg/mL of sodium thiosulfate, is streaked on SA medium. When the solution contains east, 0.1 mL of either of the samples prepared as the same as those of bacteria is streaked on PDA medium. For control samples, the sterilized deionized water is used instead of the sterilized deionized water containing sodium thiosulfate. After the incubation of them, colonies appeared on the plates are counted.

5) Evaluation

In order to evaluate the bactericidal effects at each sample with different concentration, appeared colony numbers are measured at each treatment time as viable microbial numbers.

(2) Assay Results

As shown in the following Table 2 to Table 5, all of the bacterial used in the assays are died by treatment of the hypochlorite solution at the concentration of 5 ppm for 0.5 min.

TABLE 2
Bactericidal Effect at each concentration against E. coli (Viable
microbial number)

| | Treatment time | | |
|---|---|---|---|
| Conc. | 0.5 min. | 5 min. | 10 min. |
| 200 ppm | 0 | 0 | 0 |
| 20 ppm | 0 | 0 | 0 |
| 5 ppm | 0 | 0 | 0 |
| 2 ppm | 340 | 12 | 0 |
| 1 ppm | 350 | 24 | 0 |
| 0.5 ppm | 310 | 21 | 0 |

Control: 490

TABLE 3
Bactericidal Effect at each concentration against Salmonella
(Viable microbial number)

| | Treatment time | | |
|---|---|---|---|
| Conc. | 0.5 min. | 5 min. | 10 min. |
| 200 ppm | 0 | 0 | 0 |
| 20 ppm | 0 | 0 | 0 |
| 5 ppm | 0 | 0 | 0 |
| 2 ppm | 270 | 3 | 0 |
| 1 ppm | 230 | 12 | 0 |
| 0.5 ppm | 270 | 23 | 0 |

Control: 680

TABLE 4
Bactericidal Effect at each concentration against Candida
(Viable microbial number)

| | Treatment time | | |
|---|---|---|---|
| Conc. | 0.5 min. | 5 min. | 10 min. |
| 200 ppm | 0 | 0 | 0 |
| 20 ppm | 0 | 0 | 0 |
| 5 ppm | 0 | 0 | 0 |
| 2 ppm | 710 | 3 | 0 |
| 1 ppm | 680 | 63 | 0 |
| 0.5 ppm | 880 | 58 | 0 |

Control: 1,100

TABLE 5
Bactericidal Effect at each concentration against P. aeruginosa
(Viable microbial number)

| | Treatment time | | |
|---|---|---|---|
| Conc. | 0.5 min. | 5 min. | 10 min. |
| 200 ppm | 0 | 0 | 0 |
| 20 ppm | 0 | 0 | 0 |
| 5 ppm | 0 | 0 | 0 |
| 2 ppm | 660 | 0 | 0 |
| 1 ppm | 550 | 0 | 0 |
| 0.5 ppm | 530 | 0 | 0 |

Control: 920

(Comparative assay for the bactericidal effects against a variety of spores (formed by bacillus sp.) of the hypochlorite solution described as one embodiment of the present invention and sodium hypochlorite solution

(1) Assay Samples

The hypochlorite solution or the sodium hypochlorite solution is prepared as shown in Table 6.

TABLE 6

| | | Effective chlorine | Redox potential | |
|---|---|---|---|---|
| | | conc. (ppm) | (mV) | pH |
| hypochlorite solution | A | 280 | +1,140 | 6.3 |
| | B | 320 | +1,140 | 6.7 |
| | C | 57 | +1,100 | 6.9 |
| sodium hypochlorite | D | 3,300 | +877 | 10.4 |
| solution | E | 1,500 | +940 | 9.9 |
| | F | 350 | +988 | 9.1 |

(2) Assay Method

1) Bacteria for the Assay

The comparative assay of the bactericidal effects is conducted by using following bacteria. Here, the bactericidal effects of hypochlorite solution described as one embodiment of the present invention and sodium hypochlorite solution are compared.

Bacillus subtilis NBRC 13719

Bacillus cereus NBRC 13494

Bacillus licheniformis NBRC 12200

2) Preparation of Spore Solutions

Three bacteria of Bacillus sp. used in the assay are picked up from colonies formed on stores slants, and suspended in the sterilized deionized water. Then the suspension is heated at 80° C. for 15 min. Then, the suspension is streaked on NA (normal agar) plate and incubated at 35° C. for 3 days to form colonies. The bacteria are picked up from the spore rich colonies, and then the suspension is heated at 80° C. for 15 min. The suspension is streaked on NA (normal agar) plate and incubated at 35° C. for 4 to 6 days to form colonies. The bacteria are picked up from the colonies and suspended in the sterilized deionized water. Then, the suspension is heated at 80° C. for 15 min to prepare the spore solution for the assay. The bacteria concentrations in 3 bacteria strains are 1 to 4×10⁶/mL.

3) Sporicidal Assay Method

0.5 mL of the spore solution is inoculated in 4.5 mL of each sample solution, and then mixed. At the time point of 0.5 min., 1 min., 2 min., and 4 min. from the start, 20 μL portions is taken out from each sample and suspended in 2 mL of the sterilized deionized water containing 1 mg/mL sodium thiosulfate. Then, the suspension is 10-fold diluted by using the same the sterilized deionized water containing sodium thiosulfate, and then streaked on NA medium plates. As Control, the sterilized deionized water is used. The plates were incubated at 35° C. for 2 days, and the colonies appeared on the plates were counted.

4) Evaluation

The sporicidal effect in each sample with different concentration was evaluated by measuring viable spore number in each treatment time.

(3) Assay Results

1) Sporicidal Results in Bacillus subtilis

As shown in the following Table 7, the spores of Bacillus subtilis were died out with 2 minutes treatment, when the sample A or B was used. However, about ½ of the spores were survived after 4 minute treatment compared with those of Control, when the sample C was used. About ⅕ to ½ of the spores were survived in all of Control D, Control E, and Control F, when the sodium hypochlorite solution was used.

TABLE 7
Viable spore number produced by Bacillus subtilis sp. after treatment
either of the hypochlorite solution or sodium hypochlorite solution

| | | Effective chlorine | | Bacteria conc. | Treatment time (min.) | | | |
|---|---|---|---|---|---|---|---|---|
| | | conc. (ppm) | pH | (cfu/ml) | 0.5 | 1 | 2 | 4 |
| Hypochlorite | A | 280 | 6.3 | 1.3 × 10⁵ | 79 | 21 | 0 | 0 |
| solution | B | 320 | 6.7 | | 108 | 4 | 0 | 0 |
| | C | 57 | 6.9 | | 100 | 113 | 100 | 57 |
| Sodium | D | 3,300 | 10.4 | | 129 | 108 | 91 | 34 |
| hypochlorite | E | 1,500 | 9.9 | | 136 | 104 | 76 | 24 |
| solution | F | 350 | 9.1 | | 108 | 104 | 84 | 69 |

| | | | | | | |
|---|---|---|---|---|---|---|
| Control | 0 | 6.4 | 134 | 129 | 121 | 126 |

2) The Sporicidal Test in Bacillus cereus

As shown in Table 8, the spores of Bacillus subtilis were died out with 1 minute treatment or 4 minutes treatment, when the sample A or B was used. However, some of the spores were survived after 4 minute treatment compared with those of Control, when the sample C was used. About ¼ to ½ of the spores were survived in all of Control D or Control E, when the sodium hypochlorite solution was used.

TABLE 8
Viable spore number of the Bacillus cereus after treatment either
of the hypochlorite solution or sodium hypochlorite solution

| | | Effective | | | | | | |
|---|---|---|---|---|---|---|---|---|
| | | chlorine | | Bacteria | Treatment time (min.) | | | |
| | | conc. (ppm) | pH | conc. (cfu/ml) | 0.5 | 1 | 2 | 4 |
| Hypochlorite | A | 280 | 6.3 | 2.0 × 10⁵ | 76 | 0 | 0 | 0 |
| solution | B | 320 | 6.7 | | 95 | 32 | 19 | 0 |
| | C | 57 | 6.9 | | 82 | 136 | 107 | 115 |
| Sodium | D | 3,300 | 10.4 | | 119 | 104 | 47 | 0 |
| hypochlorite | E | 1,500 | 9.9 | | 127 | 114 | 66 | 0 |
| solution | F | 350 | 9.1 | | 126 | 111 | 76 | 67 |

| | | | | | | |
|---|---|---|---|---|---|---|
| Control | 0 | 6.4 | 148 | 186 | 171 | 165 |

3) The Sporicidal Test in Bacillus licheniformis

As shown in Table 9, the spores of Bacillus subtilis were died out with 2 minute treatment, when the sample A or B was used. However, about ½ of the spores were survived after 4 minute treatment compared with those of Control, when the sample C was used. About ⅓ to ½ of the spores were survived with 4 minute treatment in all of Control D, Control E, or Control F, when the sodium hypochlorite solution was used.

TABLE 9
Viable bacterial number after spores of Bacillus licheniformis was
treated with hydrochlorite solution or sodium hydrochlorite solution

| | | Effective | | Initial bacterial | | | | |
|---|---|---|---|---|---|---|---|---|
| | | chloride | | number | Treatment time (min.) | | | |
| | | conc. (ppm) | pH | (CFU/mL) | 0.5 | 1 | 2 | 4 |
| Hypochlorite | A | 280 | 6.3 | | 335 | 37 | 0 | 0 |
| solution | B | 320 | 6.7 | | 266 | 43 | 0 | 0 |
| | C | 57 | 6.9 | 4.0 × 10⁵ | 355 | 252 | 328 | 237 |
| Sodium | D | 3,300 | 10.6 | | 313 | 347 | 293 | 202 |
| hypochlorite | E | 1,500 | 9.9 | | 238 | 296 | 184 | 127 |
| solution | F | 350 | 9.1 | | 322 | 352 | 223 | 233 |

| | | | | | | |
|---|---|---|---|---|---|---|
| Control | 0 | 6.4 | 349 | 370 | 381 | 393 |

The present invention has the most distinctive characteristic that water added into the hypochlorite solution having mild acidity is only distilled water. As a result, the hypochlorite solution having both of excellent microbicidal effects and utility as pharmaceuticals is provided, by using the distilled water as that to be added to the hypochlorite solution.

It should be noted that the water used for preparing each solution such as sodium hypochlorite solution, distilled hydrochloride solution and the like is only the purified water defined as Japanese Pharmacopoeia.

### INDUSTRIAL APPLICABILITY

As explained above, according to the present invention, hypochlorite solution having excellent both of bactericidal effects and safety, which is useful as medical supplies or pharmaceuticals are provided. The hypochlorite solution of the present invention is also utilized as the bactericidal agent in a variety of fields such as a detergent for cooking utensils and the like.

1-6. (canceled)

7. A microbicide for a Bacillus spore, said microbicide including a hypochlorite aqueous solution comprising chlorine from 280 to 320 ppm as effective chlorine concentration, with a pH from 6.3 to 6.7.

8. The microbicide for a Bacillus spore according to claim 7, wherein
said hypochlorite aqueous solution consists of sodium hydrochlorite as a food additive, purified water as defined in the Japanese Pharmacopoeia, and dilute hydrochloric acid solution as defined in the Japanese Pharmacopoeia.

9. The microbicide for a Bacillus spore according to claim 7, wherein
said Bacillus spore is any spore of genus Bacillus selected from the group consisting of Bacillus subtilis, Bacillus cereus, and Bacillus licheniformis.

10. A method for disinfecting a Bacillus spore, wherein
a member of interest for disinfection is immersed in a microbicide for a Bacillus spore according to claim 7 for a period from 0.5 minutes to 4 minutes.

11. A microbicide for a Bacillus spore, comprising chlorine from 57 to 320 ppm as effective chlorine concentration, with a pH from 6.3 to 6.9.

12. A method for disinfecting a Bacillus spore, wherein
a member of interest for the disinfection is immersed in a microbicide for a Bacillus spore according to claim 11 for a period from 0.5 minutes to 4 minutes.

13. A microbicide for a microbe, comprising chlorine from 0.5 to 200 ppm of chlorine as effective chlorine concentration, with a pH of 6.4.

14. The microbicide according to claim 13, in the form of a hypochlorite aqueous solution consisting of sodium hydrochlorite as a food additive, purified water as defined in the Japanese Pharmacopoeia, and dilute hydrochloric acid solution as defined in the Japanese Pharmacopoeia.

15. The microbicide according to claim 13, wherein
said microbe is any bacteria selected from the group consisting of E. coli, Salmonella enteritidis, candida, and Pseudomonas aeruginosa.

16. A method for disinfecting a microbe, wherein
a member of interest for the disinfection is immersed in a microbicide according to claim 13 for a period from 0.5 minutes to 10 minutes.

17. The method for disinfecting a microbe according to claim 16, wherein
said member of interest for the disinfection is immersed in said microbicide for a period not less than 5 minutes, when the effective chlorine concentration is from 0.5 ppm to 5 ppm.

18. The microbicide for a Bacillus spore according to claim 8, wherein
said Bacillus spore is any spore of genus Bacillus selected from the group consisting of Bacillus subtilis, Bacillus cereus, and Bacillus licheniformis.

19. A method for disinfecting a Bacillus spore, wherein
a member of interest for disinfection is immersed in a microbicide for a Bacillus spore according to claim 8 for a period from 0.5 minutes to 4 minutes.

20. A method for disinfecting a Bacillus spore, wherein
a member of interest for disinfection is immersed in a microbicide for a Bacillus spore according to claim 9 for a period from 0.5 minutes to 4 minutes.

21. A method for disinfecting a Bacillus spore, wherein
a member of interest for disinfection is immersed in a microbicide for a Bacillus spore according to claim 18 for a period from 0.5 minutes to 4 minutes.

22. The microbicide according to claim 14, wherein
said microbe is any bacteria selected from the group consisting of E. coli, Salmonella enteritidis, candida, and Pseudomonas aeruginosa.

23. A method for disinfecting a microbe, wherein
a member of interest for the disinfection is immersed in a microbicide according to claim 14 for a period from 0.5 minutes to 10 minutes.

24. A method for disinfecting a microbe, wherein
a member of interest for the disinfection is immersed in a microbicide according to claim 15 for a period from 0.5 minutes to 10 minutes.

25. A method for disinfecting a microbe, wherein
a member of interest for the disinfection is immersed in a microbicide according to claim 22 for a period from 0.5 minutes to 10 minutes.

26. The method for disinfecting a microbe according to claim 23, wherein
said member of interest for the disinfection is immersed in said microbicide for a period not less than 5 minutes, when the effective chlorine concentration is from 0.5 ppm to 5 ppm.
